(19) United States
(12) Patent Application Publication
(10) Pub. No.: US 2010/0117971 A1
(43) Pub. Date: May 13, 2010

(54) Data Input Method

(76) Inventor: Chun-Yu CHEN, Hsin-Chu (TW)

Correspondence Address: LanWay IPR Services, P.O. box 223205, Chantilly, VA, 20153, US

(21) Appl. No.: 12/491,261

(22) Filed: Jun. 25, 2009

(30) Foreign Application Priority Data
Nov. 13, 2008 (TW) 097143806

(51) Int. Cl. G06F 3/041

(52) U.S. Cl. 345/173

(57) ABSTRACT

A data input method is adapted to be implemented in an electronic device equipped with a touch panel. The data input method includes following sequential steps: defining a plurality of linear directions; determining an operation of moving along one of the linear directions on the touch panel as an input data; and when the direction of moving changes, determining a subsequent operation of moving along one of the linear directions on the touch panel as another input data.

### CROSS-REFERENCE TO RELATED APPLICATIONS

This application is based upon and claims the benefit of priority from the prior Taiwanese Patent Application No. 097143806, filed Nov. 13, 2008, the entire contents of which are incorporated herein by reference.

### BACKGROUND

1. Field of the Invention

The present invention generally relates to a data input method adapted to be implemented in an electronic device equipped with a touch panel.

2. Description of the Related Art

With the rapid development of science and technology, input devices of electronic products have become increasingly diverse. In many electronic products, touch panels have replaced keyboards to be used as main input devices and are convenient to input data for users (for example, to input an unlock code, or a lock code.).

Please refer to the Japanese patent publication No. 2002-282724, an electric lock device is disclosed, the disclosure of the Japanese patent publication No. 2002-282724 is fully incorporated herein by reference. The electric lock device uses a touch panel as an input interface for an unlock code. In particular, a finger or the like may input a pattern figure such as ┌◯┘ or ┌Δ┘, from the touch panel. Then the input pattern figure is compared with a pattern figure for unlocking the electric lock stored in a figure memory, and when the input pattern figure is coincided with the stored pattern figure, the input pattern figure is decided as a symbol of the unlock code. Finally, a CPU circuit outputs a signal to determine whether unlocking the electric lock or not. However, since the above-mentioned unlocking method uses the pattern figure to determine the symbol, the input of two adjacent symbols of the unlock code may exist a time interval and may result in the input of data inconvenient.

### BRIEF SUMMARY

The present invention is directed to a data input method, and the present invention may be convenient for data input.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to achieve one or part of or all the objectives or other objectives, a data input method in accordance with an embodiment of the present invention is provided. The data input method is adapted to be implemented in an electronic device equipped with a touch panel. The data input method includes following steps: defining a plurality of linear directions; determining an operation of moving along one of the linear directions on the touch panel as an input data; and when the direction of moving changes, determining a subsequent operation of moving along one of the linear directions on the touch panel as another input data.

In one embodiment of the present invention, each of the linear directions is one of a horizontal direction, a vertical direction substantially perpendicular to the horizontal direction, and a tilt direction tilted relative to the horizontal direction.

In one embodiment of the present invention, a tilt angle of the tilt direction relative to the horizontal direction is in one of a first quadrant with a range of angle larger than 0 degree and less than 90 degrees, a second quadrant with a range of angle larger than 90 degrees and less than 180 degrees, a third quadrant with a range of angle larger than 180 degrees and less than 270 degrees, and a fourth quadrant with a range of angle larger than 270 degrees and less than 360 degrees. All tilt angles in a same one of the quadrants represent a same tilt direction, and tilt angles in different quadrants represent different tilt directions.

In one embodiment of the present invention, a tilt angle of the tilt direction relative to the horizontal direction is in one of a first quadrant with a range of angle larger than 0 degree and less than 90 degrees, a second quadrant with a range of angle larger than 90 degrees and less than 180 degrees, a third quadrant with a range of angle larger than 180 degrees and less than 270 degrees, and a fourth quadrant with a range of angle larger than 270 degrees and less than 360 degrees. The quadrant of the tilt angle falling in has a dividing angle and is demarcated into two domains by the dividing angle, the tilt angle is in one of the domain with a range of angle larger than the dividing angle and the domain with a range of angle less than the dividing angle. All tilt angles in a same one of the domains represent a same tilt direction, and tilt angles in different domains represent different tilt directions.

In one embodiment of the present invention, a combination of the input data is a code of electric lock, and the code of electric lock is for locking or unlocking.

In above-mentioned embodiments of the present invention, a direction of moving is used to determine an inputted symbol. In particular, the operation of moving along one of a plurality of linear directions on the touch panel is determined as one input data, and when the direction of moving changes, a subsequent operation of moving along one of the plurality of linear directions on the touch panel is determined as another input data. Therefore, the data input method may input different data by changing the direction of moving, such that the input operation is simplified, and the input for data becomes convenient as a result. Furthermore, for the electronic device equipped with a touch panel, the data input method only needs to add the software to achieve the above-mentioned performance and may not require any additional element. Accordingly, the use of the data input method may not increase any additional hardware cost and thus the competition strength of product is increased.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a flow chart of a data input method in accordance with an embodiment of the present invention.

FIG. 2 shows a linear direction of an embodiment of the present invention, and the linear direction is a tilt direction.

FIG. 3 shows a linear direction of an embodiment of the present invention, and the linear direction is another tilt direction.

FIG. 4 shows a linear direction of an embodiment of the present invention, and the linear direction is still another tilt direction.

FIG. 5 shows a linear direction of an embodiment of the present invention, and the linear direction is even still another tilt direction.

FIG. 6 shows a linear direction of an embodiment of the present invention, and the linear direction is a positive vertical direction.

FIG. 7 shows a linear direction of an embodiment of the present invention, and the linear direction is a negative vertical direction.

FIG. 8 shows a linear direction of an embodiment of the present invention, and the linear direction is a positive horizontal direction.

FIG. 9 shows a linear direction of an embodiment of the present invention, and the linear direction is a negative horizontal direction.

FIG. 10A shows a circumstance of a plurality of input data are continuously inputted, in accordance with an embodiment of the present invention.

FIG. 10B shows a circumstance of a plurality of input data are discontinuously inputted, in accordance with an embodiment of the present invention.

FIG. 11 shows all tilt angles in the first quadrant represent a same tilt direction, in accordance with an embodiment of the present invention.

FIG. 12 shows the first quadrant is demarcated into two domains by a dividing angle, all tilt angles in a same one of the domains represent a same tilt direction, and tilt angles in different domains represent different directions.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

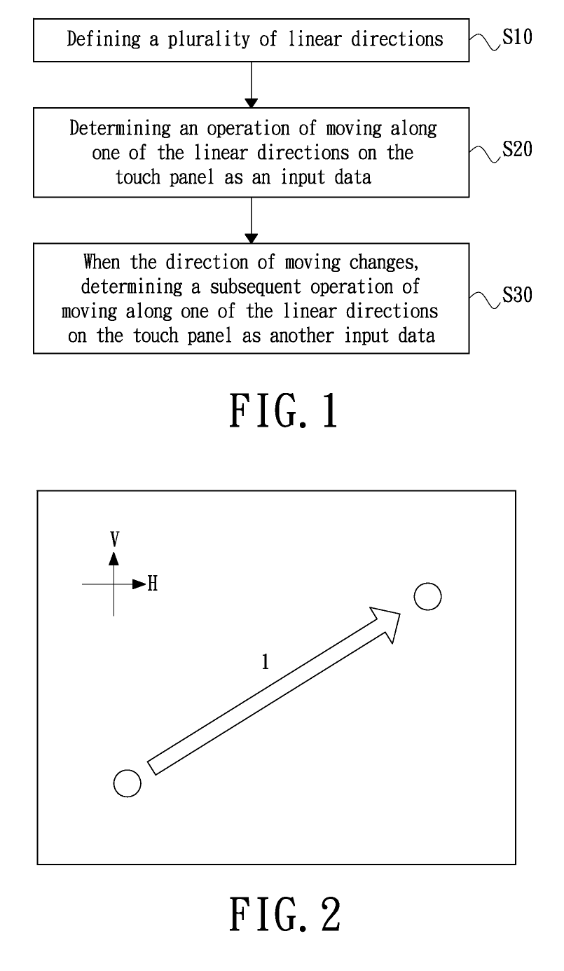

Referring to FIG. 1, a data input method in accordance with an embodiment of the present invention is provided. The data input method is adapted to be implemented in an electronic device equipped with a touch panel. The data input method includes sequential steps S10˜S30. In particular, step S10: defining a plurality of linear directions; step S20: determining an operation of moving along one of the linear directions on the touch panel as one input data; and step S30: when the direction of moving changes, determining a subsequent operation of moving along one of the linear directions on the touch panel as another input data.

More specifically, please refer to FIGS. 2 through 9, each of FIGS. 2 through 9 shows a linear direction, and each linear direction represents an inputted symbol as one input data.

The linear direction as shown in FIG. 2 is a tilt direction tilted relative to the horizontal direction H. A tilt angle of the tilt direction relative to the positive direction of the horizontal direction H is in the first quadrant with a range of angle 0˜90 (i.e., larger than 0 and less than 90) degrees. An operation of an object (indicated by circles of FIG. 2) moving along the tilt direction, as indicated by the arrow, on the touch panel is determined as one input data, such as symbol “1”.

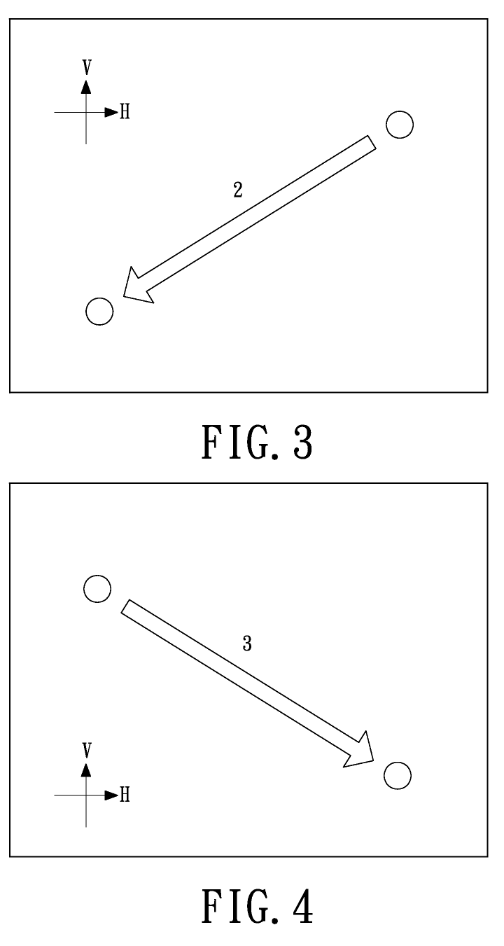

The linear direction as shown in FIG. 3 is another tilt direction tilted relative to the horizontal direction H. A tilt angle of the tilt direction relative to the positive direction of the horizontal direction H is in the third quadrant with a range of angle 180˜270 (i.e., larger than 180 and less than 270) degrees. An operation of an object (indicated by circles of FIG. 3) moving along the tilt direction, as indicated by the arrow, on the touch panel is determined as another input data, such as symbol “2”.

The linear direction as shown in FIG. 4 is still another tilt direction tilted relative to the horizontal direction H. A tilt angle of the tilt direction relative to the positive direction of the horizontal direction H is in the fourth quadrant with a range of angle 270˜360 (i.e., larger than 270 and less than 360) degrees. An operation of an object (indicated by circles of FIG. 4) moving along the tilt direction, as indicated by the arrow, on the touch panel is determined as another input data, such as symbol “3”.

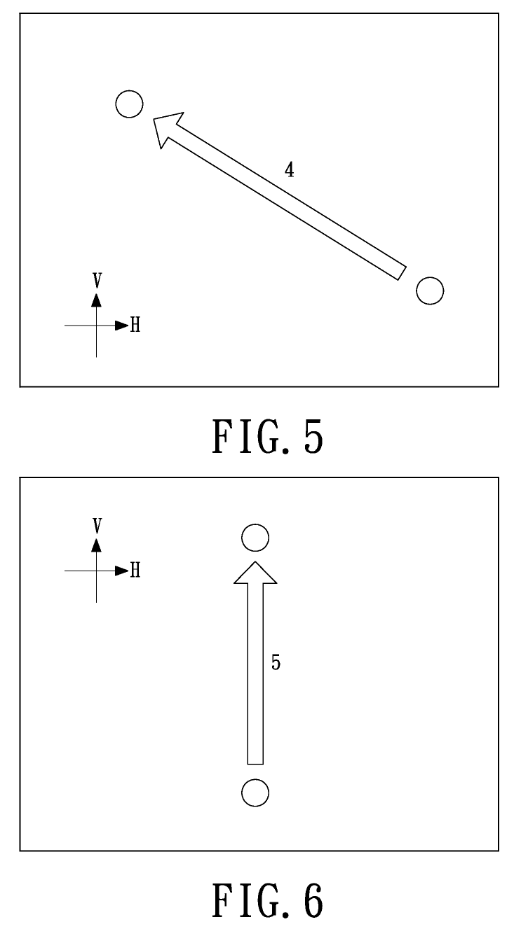

The linear direction as shown in FIG. 5 is even still another tilt direction tilted relative to the horizontal direction H. A tilt angle of the tilt direction relative to the positive direction of the horizontal direction H is in the second quadrant with a range of angle 90˜180 (i.e., larger than 90 and less than 180) degrees. An operation of an object (indicated by circles of FIG. 5) moving along the tilt direction, as indicated by the arrow, on the touch panel is determined as another input data, such as symbol “4”.

The linear direction as shown in FIG. 6 is a positive direction of the vertical direction V substantially perpendicular to the horizontal direction H. An operation of an object (indicated by circles of FIG. 6) moving along the positive vertical direction, as indicated by the arrow, on the touch panel is determined as one input data, such as symbol “5”.

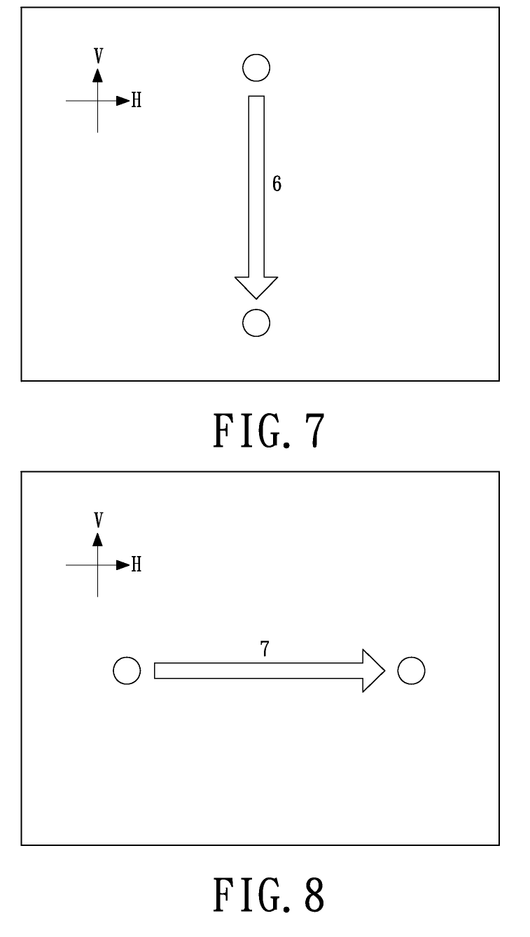

The linear direction as shown in FIG. 7 is a negative direction of the vertical direction V substantially perpendicular to the horizontal direction H. An operation of an object (indicated by circles of FIG. 7) moving along the negative vertical direction, as indicated by the arrow, on the touch panel is determined as another input data, such as symbol “6”.

The linear direction as shown in FIG. 8 is a positive direction of the horizontal direction H. An operation of an object (indicated by circles of FIG. 8) moving along the positive horizontal direction, as indicated by the arrow, on the touch panel is determined as one input data, such as symbol “7”.

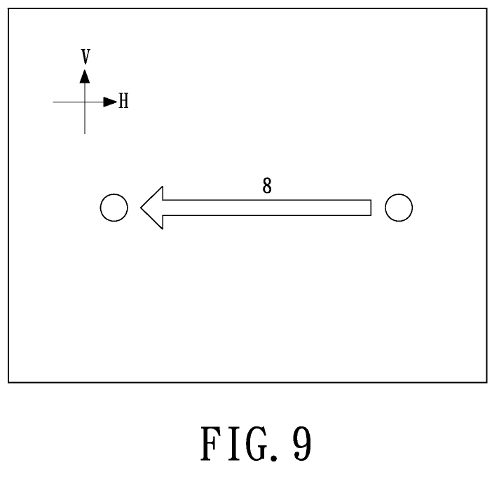

The linear direction as shown in FIG. 9 is a negative direction of the horizontal direction H. An operation of an object (indicated by circles of FIG. 9) moving along the negative horizontal direction, as indicated by the arrow, on the touch panel is determined as another input data, such as symbol “8”.

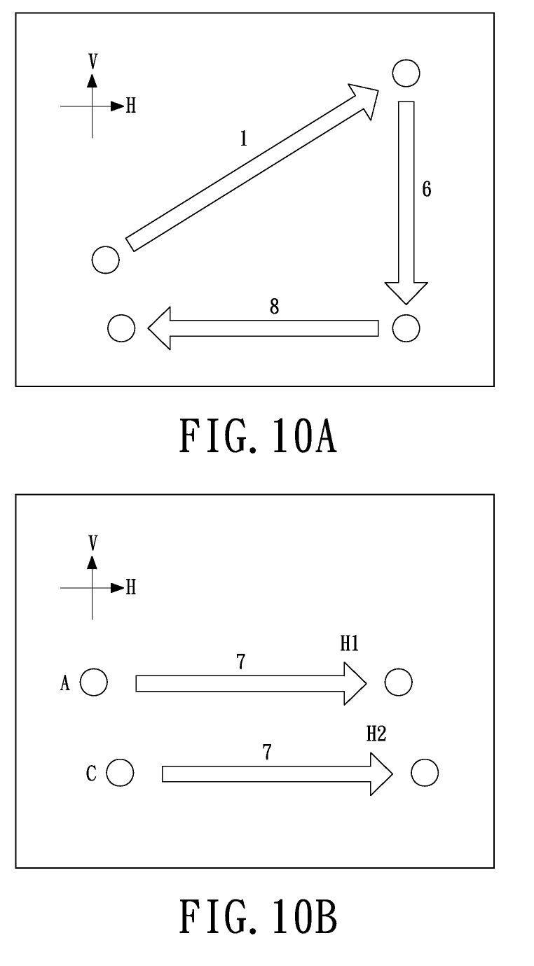

FIG. 10A shows an operation of an object (indicated by circles of FIG. 10) moving along a tilt direction with a tilt angle in the first quadrant, the negative vertical direction, and the negative horizontal direction to continuously input the data “1” “6” “8”. In particular, the operation of the object moving along the tilt direction as shown in FIG. 10A on the touch panel is used as the input of the symbol “1”. When the direction of moving changes from the tilt direction to the negative vertical direction, the subsequent operation of moving along the negative vertical direction on the touch panel is used as the input of the symbol “6”. When the direction of moving changes from the negative vertical direction to the negative horizontal direction, the subsequent operation of moving along the negative horizontal direction on the touch panel is used as the input of the symbol “8”. Therefore, the continuous input for the data “1” “6” “8” is completed. In a brief, during the process of the continuous input of the data “1” “6” “8”, once the direction of moving changes, a subsequent operation of continuing to move along the direction of change is determined as another input data.

Understandably, the data input method of the embodiment of the present invention is not limited to the operations of moving along the three linear directions as shown in FIG. 10A so as to continuously input three data. The data input method may perform the operations of moving along different combinations of a plurality of linear directions to input different combinations of a plurality of data.

Furthermore, the data input method of the embodiment of the present invention is not limited to the circumstance of the plurality of data inputted continuously as shown in FIG. 10A and may be a circumstance of a plurality of data inputted discontinuously as shown in FIG. 10B. In particular, as shown in FIG. 10B, an operation of starting from a position A and moving along the positive horizontal direction H1 on the touch panel is used as the input of the symbol “7” and determined as a first data. After the input of the first data, the object leaves from the touch panel and returns to a position C. At this time, the direction of moving of the object has been changed for the first time, but the operation of the change of the direction of moving of the object is not determined as a second data, and the position C is only used as an initial position associated with an operation for the input of the second data. Then, an operation of the object starting from the position C and moving along the positive horizontal direction H2 on the touch panel is used as the input of the symbol “7” and determined as the second data. As a result, the discontinuous input of a plurality of data “7” “7” is completed. In a brief, during the process of the discontinuous input of the data “7” “7”, after the input of each data, the direction of moving changes at the first time is only for indicating the start of the operation associated with the input of the subsequent data. In addition, the moving direction of the object corresponding to the subsequent data is not limited in the direction of moving changing at the first time.

It should be noted that the linear directions such as the above-mentioned horizontal direction, vertical direction and tilt directions, defined in the data input method of the embodiment of the present invention are not limited to represent the symbols “1”˜“8” as shown in FIGS. 2-9 and may represent any symbols determined by practical needs.

Furthermore, a combination of data inputted by the data input method of the embodiment of the present invention may be a code of an electric lock for locking the electric lock. Therefore, the data input method may be implemented in an electric lock, such as a boot lock of a notebook computer, a key lock or a password lock of a handheld device (such as a mobile phone). Of course, the combination of data inputted by the data input method of the embodiment of the present invention may also be a code for unlocking the electric lock.

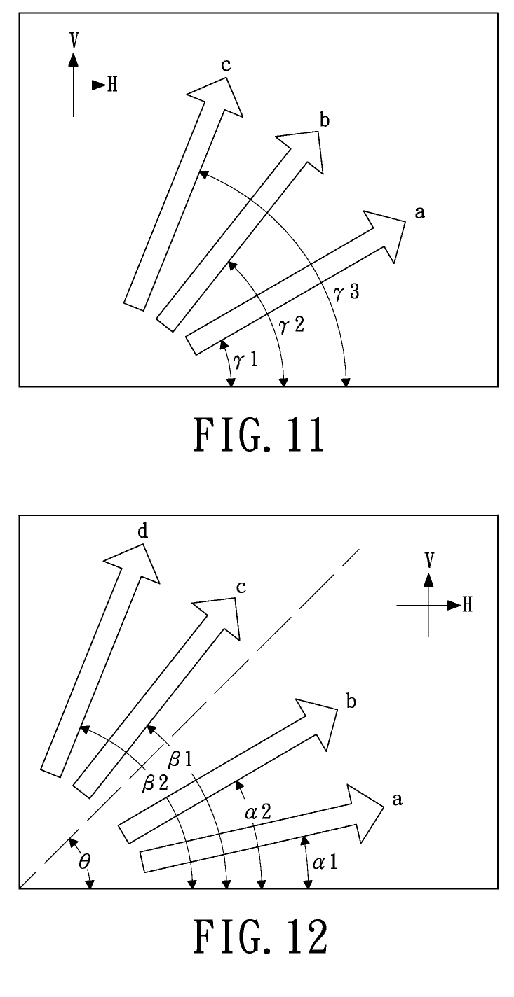

Referring to FIG. 11, in another embodiment of the present invention, tilt angles γ1, γ2, and γ3 in the same quadrant (such as the first quadrant as shown in FIG. 11) represent a same tilt direction, while tilt angles in different quadrants represent different tilt directions.

Referring to FIG. 12, in still another embodiment of the present invention, at least one of the first, second, third, and fourth quadrants, such as the first quadrant as shown in FIG. 12, each has a dividing angle θ (e.g., 45 degrees). In the illustrated embodiment, the dividing angle θ demarcates the first quadrant into two domains. One of the domains has a range of angle larger than the dividing angle θ, and the other one domain has a range of angle less than the dividing angle θ. Furthermore, all tilt angles in a same domain, such as α1 and α2, or β1 and β2, represent a same tilt direction, and tilt angles in different domains represent different tilt directions. The tilt angles α1 and α2 are less than the dividing angle θ and represent a same tilt direction, and the tilt angle β1 and β2 are larger than the dividing angle θ and represent another tilt direction.

In summary, the data input method in accordance with the embodiments of the present invention uses a direction of moving to determine the inputted symbol. In particular, the operation of moving along one of a plurality of linear directions on the touch panel is determined as one input data, and when the direction of moving changes, a subsequent operation of moving along one of the plurality of linear directions on the touch panel is determined as another input data. Therefore, the present data input method may input different data by changing the direction of moving, such that the input operation is simplified, and the input for data becomes convenient as a result. Furthermore, for the electronic device equipped with the touch panel, the data input method may only need to add a software to achieve the above-mentioned performance and may not require any additional element. Accordingly, the use of the data input method may not increase any additional hardware cost and thus the competition strength of product may be increased.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A data input method adapted to be implemented in an electronic device, the electronic device comprising a touch panel, and the data input method comprising:
defining a plurality of linear directions;
determining an operation of moving along one of the linear directions on the touch panel as an input data; and
when the direction of moving changes, determining a subsequent operation of moving along one of the linear directions on the touch panel as another input data.

2. The data input method as claimed in claim 1, wherein each of the linear directions is one of a horizontal direction, a vertical direction substantially perpendicular to the horizontal direction, and a tilt direction tilted relative to the horizontal direction.

3. The data input method as claimed in claim 2, wherein a tilt angle of the tilt direction relative to the horizontal direction is in one of a first quadrant with a range of angle larger than 0 degree and less than 90 degrees, a second quadrant with a range of angle larger than 90 degrees and less than 180 degrees, a third quadrant with a range of angle larger than 180 degrees and less than 270 degrees, and a fourth quadrant with a range of angle larger than 270 degrees and less than 360 degrees; all tilt angles in a same one of the quadrants represent a same tilt direction, and the tilt angles in the different quadrants represent the different tilt directions.

4. The data input method as claimed in claim 2, wherein a tilt angle of the tilt direction relative to the horizontal direction is in one of a first quadrant with a range of angle larger than 0 degree and less than 90 degrees, a second quadrant with a range of angle larger than 90 degrees and less than 180 degrees, a third quadrant with a range of angle larger than 180 degrees and less than 270 degrees, and a fourth quadrant with a range of angle larger than 270 degrees and less than 360 degrees; the quadrant of the tilt angle falling in has a dividing angle and is demarcated into two domains by the dividing angle, the tilt angle is in one of the domain with a range of angle larger than the dividing angle and the domain with a range of angle less than the dividing angle; all tilt angles in a same one of the domains represent a same tilt direction, and the tilt angles in the different domains represent the different tilt directions.

5. The data input method as claimed in claim 1, wherein a combination of the input data is a code of an electric lock.

6. The data input method as claimed in claim 5, wherein each of the linear directions is one of a horizontal direction, a vertical direction substantially perpendicular to the horizontal direction, and a tilt direction tilted relative to the horizontal direction.

7. The data input method as claimed in claim 6, wherein a tilt angle of the tilt direction relative to the horizontal direction is in a first quadrant with a range of angle larger than 0 degree and less than 90 degrees, a second quadrant with a range of angle larger than 90 degrees and less than 180 degrees, a third quadrant with a range of angle larger than 180 degrees and less than 270 degrees, and a fourth quadrant with a range of angle larger than 270 degrees and less than 360 degrees; all tilt angles in a same one of the quadrants represent a same tilt direction, and the tilt angles in the different quadrants represent the different tilt directions.

8. The data input method as claimed in claim 6, wherein a tilt angle of the tilt direction relative to the horizontal direction is in one of a first quadrant with a range of angle larger than 0 degree and less than 90 degrees, a second quadrant with a range of angle larger than 90 degrees and less than 180 degrees, a third quadrant with a range of angle larger than 180 degrees and less than 270 degrees, and a fourth quadrant with a range of angle larger than 270 degrees and less than 360 degrees; the quadrant of the tilt angle falling in has a dividing angle and is demarcated into two domains by the dividing angle, the tilt angle is in one of the domain with a range of angle larger than the dividing angle and the domain with a range of angle less than the dividing angle; all tilt angles in a same one of the domains represent a same tilt direction, and the tilt angles in different domains represent the different tilt directions.

9. The data input method as claimed in claim 5, wherein the code of the electric lock is configured for locking.

10. The data input method as claimed in claim 5, wherein the code of the electric lock is configured for unlocking.
